(19) United States
(12) Patent Application Publication
(10) Pub. No.: US 2014/0244186 A1
(43) Pub. Date: Aug. 28, 2014

(54) METHOD FOR ESTIMATING THE ROLLING RESISTANCE OF A VEHICLE WHEEL

(71) Applicant: RENAULT s.a.s., Boulogne-Billancourt (FR)

(72) Inventors: Charbel El Tannoury, Versailles (FR); Guillermo Pita-Gil, Paris (FR); Nicolas Romani, Paris (FR); Franck Plestan, Nantes Cedex 3 (FR); Said Moussaoui, Nantes Cedex 3 (FR)

(73) Assignee: RENAULT s.a.s., Boulogne-Billancourt (FR)

(21) Appl. No.: 14/346,581

(22) PCT Filed: Sep. 17, 2012
(86) PCT No.: PCT/FR2012/052076

§ 371 Date: May 2, 2014

(30) Foreign Application Priority Data
Sep. 22, 2011 (FR) 1158453

(51) Int. Cl. G01L 17/00; G01P 3/00; G01L 3/02

(52) U.S. Cl. CPC G01L 17/00; G01L 3/02; G01P 3/00
USPC 702/41

(57) ABSTRACT

A method for estimating rolling resistance of a wheel of a moving vehicle, the vehicle including at least two wheels fitted with tires, the method including: measuring or estimating a value of angular velocity Ω of rotation of at least one wheel; and measuring or estimating a value of torque T applied to the wheel; the method using an observer of dynamics of the wheel that is based on a sliding mode control theory, in which input signals are the value of the angular velocity Ω of the wheel and the value of the torque T applied to the wheel.

The present invention relates to the detection and monitoring of the state of inflation of the tire of a vehicle wheel, more specifically of a motor vehicle wheel.

It is in fact vital for the safety of passengers that all vehicles have wheels of which the inflation pressure is sufficient to ensure suitable behavior of the vehicle in terms of the directional stability thereof, the handling thereof and comfort thereof. It is additionally known that an insufficient pressure of the tires leads to over-consumption.

A significant piece of information associated with the contact between the wheel and the highway is the rolling resistance force, of which the variation is highly indicative of the state of the vehicle in terms of load and inflation pressure of the tires.

In order to improve the vehicle control strategies and the tire diagnostic tools, the present invention proposes estimating the rolling resistance of a wheel and deducing therefrom the state of inflation of the tires.

It is known, from document JP2010/0249527, to estimate the rolling resistance of a tire considered in isolation, with the objective of determining the characteristics of said tire. This estimation is based on a static finite element model and does not apply to a vehicle traveling along a highway.

Documents U.S. Pat. No. 4,489,598 and US2008/0115563 also disclose test benches equipped with sensors making it possible to measure the tangential rolling resistance forces. Such an assembly does not allow a measurement of the rolling resistance during use of the vehicle, and consequently does not allow a monitoring of the pressure of the tires during travel.

The present invention proposes determining, in real time, the rolling resistance of a vehicle wheel moving on a highway from data already present in the majority of vehicles, in particular vehicles equipped with an ABS (anti-lock braking system) device, by means of a robust and reliable method. The present invention also relates to the estimation and monitoring of the pressure of a tire fitted to the wheel of a vehicle by estimating the rolling resistance of said wheel.

The present invention is achieved with the aid of a method for estimating the rolling resistance of a wheel of a moving vehicle, said vehicle having at least two wheels fitted with tires, the method comprising the following steps:
measuring or estimating the value of the angular velocity of the rotation of at least one wheel,
measuring or estimating the value of the torque applied to said wheel,
   characterized in that the method uses an observer of the dynamic of the wheel that is based on the sliding mode control theory, in which the input signals are the value of the angular velocity of the wheel and the value of the torque applied to the wheel.

Such a method thus makes it possible, from two estimated or measured signals, to obtain an estimation of the rolling resistance of each vehicle wheel by use of an observer based on the sliding mode control theory, which makes it possible in particular to confer a certain level of robustness to this method with respect to uncertainties and disturbances.

In addition, this theory also allows rapid convergence. This method for estimating rolling resistance as claimed in the preceding claim advantageously makes it possible to estimate the longitudinal velocity of the wheel.

In accordance with the invention, the observer uses the following equations applied to the wheel:

J\dot{Ω}=τ−RFₓ−C_{f}Ω,

M\dot{v}ₓ=Fₓ−F_{d}−Fᵣ,

where J and M are, respectively, the inertia of the wheel and the mass of one car quarter comprising the body and the wheel, R is the effective radius of the wheel, C_{f} is the coefficient of viscous friction of the wheel, Fₓ is the tractive force, F_{d} is the aerodynamic force, and Fᵣ is the rolling resistance force.

In addition, the tractive force is defined by the relationship Fₓ=Mgμ, where μ is the coefficient of adhesion of the wheel, this coefficient being approximated by the relationship thereof with the pseudo-sliding λ of the wheel, defined by:

$$μ ( λ ) = 2 {μ}_{0} \frac{{λ}_{0} λ}{{λ}_{0}^{2} + {λ}^{2}} , \\ with$$

$$λ = 1 - \frac{{v}_{x}}{R Ω}$$

where λ₀ is the optimum pseudo-sliding corresponding to the maximum adhesion μ₀.

This relationship between the coefficient of adhesion and the pseudo-sliding represents a more realistic approximation than the relationships commonly used, where the tractive force is expressed as being linearly dependent on the pseudo-sliding.

In accordance with an advantageous simplification of the calculation, the variation of the rolling resistance is slow in accordance with the following relationship:

\dot{F}ᵣ=η, with |η|<|η₀|,

which makes it possible to provide simplifications at observer level.

The value of the angular velocity of the rotation of the wheel is advantageously provided by sensors of the anti-lock braking system of the vehicle, which avoids a specific device for measuring this velocity.

The present invention also relates to a motor vehicle comprising a device for monitoring the pressure of the tires fitted to the vehicle wheels, using the variation of the rolling resistance of said wheels as an indicator of the variation of pressure, the vehicle being equipped with means for measuring or estimating the value of the angular velocity of the rotation of at least one wheel as well as means for measuring or estimating the value of the torque applied to said wheel, the rolling resistance being estimated in real time with the aid of a method comprising the following steps:
measuring or estimating the value of the angular velocity of the rotation of at least one wheel using the means for measuring or estimating the value of the angular velocity of the rotation of the wheel,
measuring or estimating the value of the torque applied to said wheel using the means for measuring or estimating the value of the torque applied to the wheel,
   characterized in that the vehicle comprises means for processing signals by an observer of the dynamic of the wheel that is based on the sliding mode control theory, in which the input signals are the value of the angular velocity of the wheel and the value of the torque applied to the wheel.

The vehicle advantageously comprises means for recording and comparing the rolling resistance of the vehicle wheels.

The present invention will be better understood with the aid of the following description, with reference to the accompanying figures, in which:

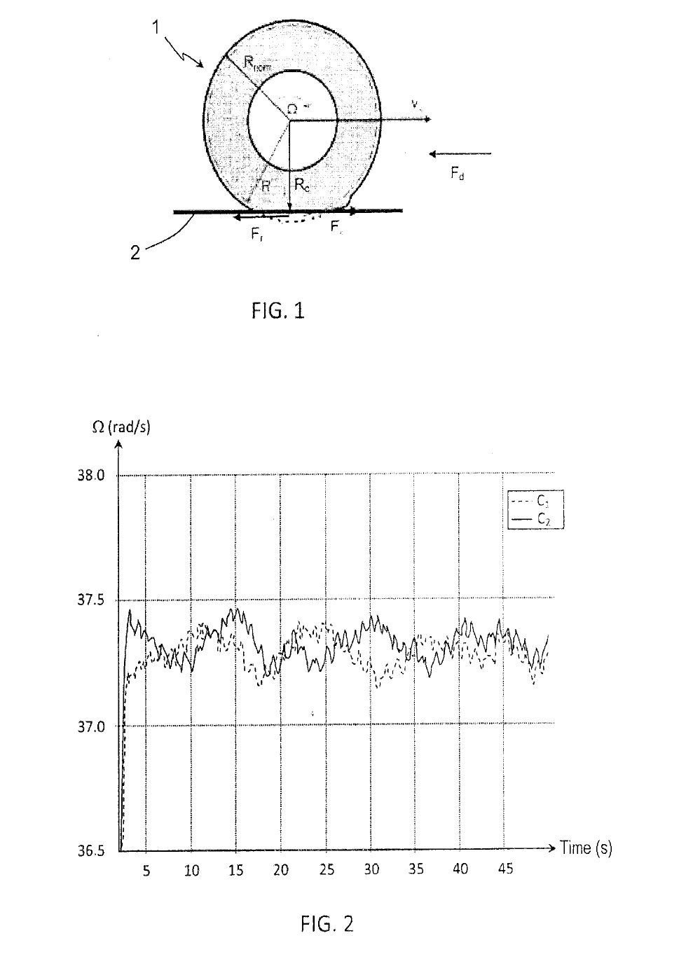

FIG. 1 is a schematic view of a wheel and of the forces applied to said wheel in a moving vehicle,

FIGS. 2 to 4 show the result of different simulations with the aid of the method according to the invention.

The present invention proposes estimating the rolling resistance force using only engine torque and angular velocity information provided advantageously by the ABS coders.

FIG. 1 shows the state of a wheel 1 fitted to a vehicle (not shown) resting on a ground surface 2. Such a wheel therefore is not considered in isolation and is thus loaded approximately by the total weight of the vehicle divided by the number of wheels ensuring the contact between the vehicle and the ground. Therefore, the radius of the wheels fitted to the tires differs from the nominal radius due to the effect of the weight of the vehicle, the nominal radius Rₙₒₘ corresponding to the outer diameter of the wheels considered separately when not fitted on the vehicle.

A radius under load R_{c} is thus defined, which corresponds to the distance between the axis of rotation of the wheel and the ground, and a dynamic radius R is also defined, which corresponds to the distance covered for one revolution of the wheel divided by 2π.

The model representing the dynamic of the wheel is based on the application of Newton's second law to the forces acting on the wheel during an acceleration phase. This makes it possible to establish the main equations of the longitudinal and rotational dynamics at the wheel:

J\dot{Ω}=τ−RFₓ−C_{f}Ω,

M\dot{v}ₓ=Fₓ−F_{d}−Fᵣ,

where Ω is the angular velocity of the wheel, R is the dynamic radius, vₓ is the linear velocity of the vehicle, C_{f} is the coefficient of viscous friction of the wheel, J and M are, respectively, the inertia of the wheel and the mass of one car quarter comprising the body and the wheel, wherein it is assumed, in the proposed example, that the vehicle has four wheels in contact with the ground.

In addition to the torque i applied to the wheel, the main forces acting on the wheel are the tractive force Fₓ, the aerodynamic force F_{d} and the rolling resistance Fᵣ, as shown in FIG. 1 and as given by the following formulas:

$${F}_{d} ( {v}_{x} ) = \frac{1}{2} ρ {A}_{d} {C}_{d} {v}_{x}^{2} , \\ {F}_{x} ( λ ) = Mg μ ( λ ) ,$$

where C_{d} is the coefficient of penetration into the air, ρ is the bulk density of the air, and A_{d} is the surface of the front zone of the vehicle. The parameter μ(λ) is the coefficient of adhesion of the wheel and is dependent on the pseudo-sliding λ of the wheel. This coefficient is defined by the following relationship:

$$\begin{matrix}λ = \frac{R Ω - {v}_{x}}{R Ω} \\ = 1 - \frac{{v}_{x}}{R Ω} .\end{matrix}$$

The relationship between μ and λ is approximated by the following function:

$$μ ( λ ) = 2 {μ}_{0} \frac{{λ}_{0} λ}{{λ}_{0}^{2} + {λ}^{2}} ,$$

where λ₀ is the optimum pseudo-sliding, corresponding to the maximum adhesion μ(λ₀)=λ₀. This relationship is more accurate and is more realistic than a linear variation between the tractive force Fₓ and the pseudo-sliding λ, as is often encountered.

The effective radius R is assumed to be constant, and the rolling resistance, of which the estimation is sought, is assumed to have a slow variation as follows

\dot{F}ᵣ=η, with η limited in accordance with the relationship |η|<|η₀|.

In accordance with the invention, an observer using only the measured value of the angular velocity of the wheel and the torque applied to said wheel is proposed. Such a solution makes it possible to estimate the velocity of the vehicle and the rolling resistance, assuming a constant radius.

The observer based on the sliding mode control theory of higher order must be of the third order. The main features of this type of observer are the robustness with respect to uncertainties and disturbances, and the convergence in finite time. In addition, they can be applied to a very broad class of observable systems.

This observation strategy has been selected because the dynamic of the rolling resistance is not known a priori and can be considered as a limited uncertainty.

In order to design the estimator, a model representing the dynamic of the wheel is necessary.

The values sought to be estimated are therefore the angular velocity of the wheels Ω, the travel speed vₓ, and the rolling resistance Fᵣ.

The state representation is thus

x=[x₁ x₂ x₃]^{T}=[ΩvₓFᵣ]^{T} with the control input U=τ, which thus makes it possible, taking into account the preceding equations, to express \dot{x} by the following relationship:

$$\dot{x} = [ \begin{matrix}- \frac{1}{J} {RF}_{x} ( x ) + {C}_{f} {x}_{1} \\ \frac{1}{M} ( {F}_{x} ( x ) - {F}_{d} ( x ) - {x}_{3} ) \\ η\end{matrix} ] + [ \begin{matrix}\frac{1}{J} \\ 0 \\ 0\end{matrix} ] u .$$

In addition, in accordance with the invention, the value of the velocity of rotation Q is known, such that the term

$$- \frac{{c}_{f}}{J} {x}_{1} + \frac{1}{J} u$$

is only dependent on known variables. It is known that the properties of observability are not modified by the consideration or non-consideration of this term, and this term will therefore be ignored hereinafter.

In addition, the value n_{obs}=0 is selected for the observer because this dynamic of rolling resistance force is slow and unknown for the observer. Thus, the observer is designed on the simplified system:

$$\begin{matrix}\dot{x} = [ \begin{matrix}- \frac{1}{J} {RF}_{x} ( x ) \\ \frac{1}{M} ( {F}_{x} ( x ) - {F}_{d} ( x ) - {x}_{3} ) \\ 0\end{matrix} ] \\ = {f}_{id} ( x ) .\end{matrix}$$

Taking into account the equations defined previously, the force Fₓ(x) is expressed by the relationship:

$${F}_{x} = 2 {μ}_{0} \frac{{λ}_{0} ( 1 - \frac{{x}_{2}}{{Rx}_{1}} )}{{λ}_{0}^{2} + {( 1 - \frac{{x}_{2}}{{Rx}_{2}} )}^{2}} Mg .$$

The following transformation is then defined:

$$\begin{matrix}Ψ ( x ) = [ \begin{matrix}y \\ \dot{y} \\ \ddot{y}\end{matrix} ] \\ = [ \begin{matrix}{x}_{1} \\ - \frac{1}{J} {RF}_{x} ( x ) \\ - {\frac{1}{J} [ \frac{d {F}_{x}}{d x} ]}^{T} \dot{x}\end{matrix} ] .\end{matrix}$$

with y=Ω=x₁ the measured output.

If the Jacobian determinant of this transformation is different from zero, the dynamic of the estimated state variables is written as follows in accordance with the technique for third-order sliding mode control:

$$\dot{\hat{x}} = {f}_{id} ( \hat{x} , y ) + χ ( y , u ) + {[ \frac{\partial ψ}{\partial x} ]}^{- 1} \cdot [ \begin{matrix}{γ}_{1} \\ {γ}_{2} \\ {γ}_{3}\end{matrix} ] ,$$

with

γ₁=2L^{1/3}|y−\hat{x}₁|^{2/3}sign(y−\hat{x}₁),

γ₂=1.5L^{1/2}|γ₁|^{1/2}sign(γ₁),

γ₃=1.1L sign(γ₂),

where L is a control parameter of the observer. The consideration of the sign allows the deviations between the estimated and measured variables to tend toward zero.

In order to check whether the proposed observer has a convergence and correct estimations of the envisaged variables, that is to say the rolling resistance and the longitudinal velocity, actual signals of angular velocity and of torque were acquired for two levels of inflation of a wheel.

The observation parameters are selected so as to be as close as possible to the actual values. Thus, the different values of the necessary parameters are: J=1.672 kg×m², R=0.305 m, M=607.5 kg, A_{d}=0.815 m², ρ=1.205 kg×m⁻³, g=9.807 m×s⁻², C_{f}=0.08 kg×m²×s⁻¹, C_{d}=0.3125, μ₀=0.9 and λ₀=0.15.

The parameter L has been set equal to 1.

The initial values \hat{x}(0) are selected in accordance with

$$\hat{x} ( 0 ) = [ \begin{matrix}15 / 0.29 \\ 15 \\ 74\end{matrix} ] .$$

For this experiment, a longitudinal velocity of the vehicle equal to 40 km/h was selected. Signals of angular velocities of the wheels and of engine torque were acquired before and after 20% tire deflation compared with the nominal pressure.

FIGS. 2 to 4 illustrate, respectively, the estimations of the angular velocity of the wheel, the longitudinal velocity of the vehicle, and the rolling resistance force as a function of travel time of the vehicle. For each of these figures, the representation in dashed lines, bearing the index 1, corresponds to the situation of nominal inflation, whereas the representation in solid lines, bearing the index 2, corresponds to the situation in which the tire has sustained a 20% pressure loss.

In FIG. 2, the curves C₁ and C₂ are very close to one another in terms of mean value, and the deviation between the two curves is less than 0.5%. The mean values are therefore difficult to differentiate, which shows that the reference of velocity rotation of the wheel is not heavily influenced by the state of pressure of the tire.

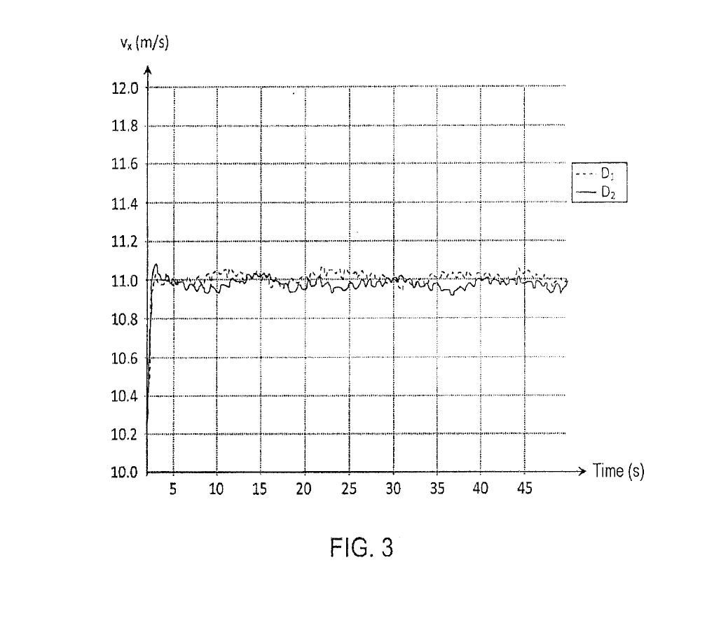

The situation is the same for FIG. 3, where the curve D₁ is very close to the curve D₂ indicating the estimation of speed after deflation of the tire, the estimated value around 11 m/s being quite consistent with the speed of 40 km/h enforced on the vehicle.

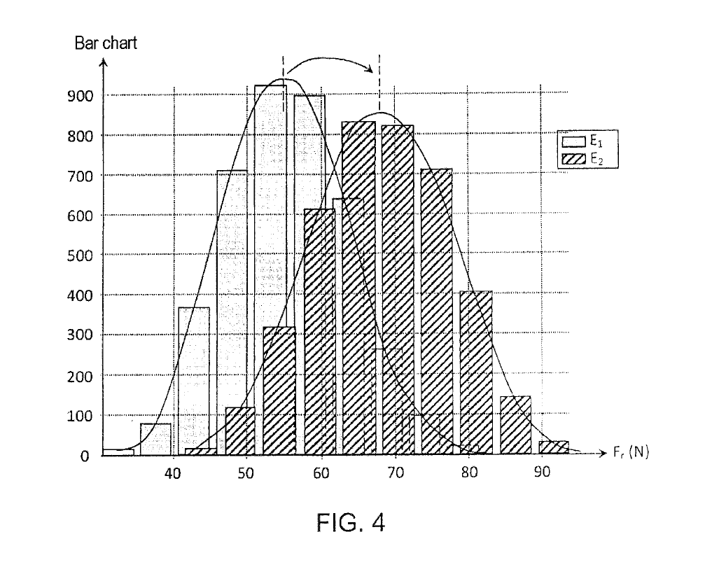

By contrast, FIG. 4 shows a clear difference between the bar charts E₁ concerning the estimation of the rolling resistance before deflation, and E₂ concerning the estimation of the rolling resistance after deflation. By showing the bar charts in Gaussian form, it is noted that the maximum value for the curve E₁ is approximately 55 N, whereas the maximum value for the curve E₂ is approximately 68 N, that is to say a deviation greater than 20% can be easily identified by data recording means.

This clear difference in the rolling resistance value bar charts, for a pressure difference of 20%, can be observed over a relatively short period of time, since the bar charts shown were obtained over 45 seconds of travel. This observation period can also be decreased, reducing the degree of certitude of the observation, or for an estimation of a more significant pressure difference.

Such a pressure difference detection can thus be communicated to the driver by means of any known device: either an acoustic or light signal or a specific interface, such as a vehicle display screen on the dashboard.

The present invention thus enables a reliable estimation of the rolling resistance and of the longitudinal velocity of the vehicle, the latter estimation being almost independent of the state of pressure of the tires, whereas the rolling resistance, by contrast, is highly dependent on the pressure of the tires, thus constituting a beneficial way of monitoring the pressure of the tires, moreover solely from estimated or measured values for the torque applied to the wheel and for the velocity rotation of the wheels.

1-8. (canceled)

9. A method for estimating rolling resistance of a wheel of a moving vehicle, the vehicle including at least two wheels fitted with tires, the method comprising:
measuring or estimating a value of angular velocity Ω of rotation of at least one wheel;
measuring or estimating a value of torque τ applied to the wheel;
wherein the method uses an observer of dynamics of the wheel that is based on a sliding mode control theory, in which input signals are the value of the angular velocity Ω of the wheel and the value of the torque τ applied to the wheel.

10. The method for estimating the rolling resistance as claimed in claim 9, wherein longitudinal velocity vₓ of the wheel is also estimated.

11. The method for estimating the rolling resistance as claimed in claim 9, wherein the observer uses following equations applied to the wheel:
j\dot{Ω}=τ−RFₓ−C_{f}Ω,
M\dot{v}ₓ=Fₓ−F_{d}−Fᵣ,
where J and M are, respectively, inertia and mass of one car quarter including a body and the wheel, R is effective radius of the wheel, C_{f} is coefficient of viscous friction of the wheel, Fₓ is tractive force, F_{d} is aerodynamic force, and Fᵣ is rolling resistance force.

12. The method for estimating the rolling resistance as claimed in claim 11, wherein the tractive force is defined by relationship Fₓ=Mgμ, where μ is coefficient of adhesion of the wheel, the coefficient being approximated by a relationship thereof with pseudo-sliding λ of the wheel, defined by:
$$μ ( λ ) = 2 {μ}_{0} \frac{{λ}_{0} λ}{{λ}_{0}^{2} + {λ}^{2}} , \\ with$$
$$λ = 1 - \frac{{v}_{x}}{R Ω}$$
where λ₀ is optimum pseudo-sliding corresponding to maximum adhesion μ₀.

13. The method for estimating the rolling resistance as claimed in claim 9, wherein the variation of the rolling resistance is slow in accordance with following relationship:
\dot{F}ᵣ=η, with |η|<|η₀|.

14. The method for estimating the rolling resistance as claimed in claim 9, wherein the value of the angular velocity of the rotation of the wheel is provided by sensors of an anti-lock braking system of the vehicle.

15. A motor vehicle comprising:
a device for monitoring pressure of tires fitted to the vehicle wheels, using a variation of rolling resistance of the wheels as an indicator of a variation of pressure,
the vehicle including means for measuring or estimating a value of angular velocity of rotation of at least one wheel and means for measuring or estimating a value of torque applied to the wheel, the rolling resistance being estimated in real time by a method comprising:
measuring or estimating the value of the angular velocity Ω of the rotation of at least one wheel using the means for measuring or estimating the value of the angular velocity of the rotation of the wheel;
measuring or estimating the value of the torque τ applied to the wheel using the means for measuring or estimating the value of the torque applied to the wheel;
wherein the vehicle further comprises means for processing signals by an observer of dynamics of the wheel that is based on a sliding mode control theory, in which input signals are the value of the angular velocity of the wheel and the value of the torque applied to the wheel.

16. The motor vehicle as claimed in claim 15, further comprising means for recording and comparing the rolling resistance of the vehicle wheels.
